(19) United States
(12) Patent Application Publication
(10) Pub. No.: US 2008/0073475 A1
(43) Pub. Date: Mar. 27, 2008

(54) Recipe stand

(76) Inventor: Tanya Gartrell, Bowerston, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/903,028

(22) Filed: Sep. 20, 2007

Related U.S. Application Data
(60) Provisional application No. 60/846,297, filed on Sep. 21, 2006.

(51) Int. Cl. A47B 97/04; B42F 17/30; G09F 1/02

(52) U.S. Cl. 248/460; 248/441.1; 248/462; 40/124.13

(57) ABSTRACT

A recipe stand for flippably mounting recipe pages thereon includes at least one information card with information printed thereon which moves between a stowed position in which typically at least part of the information is hidden from sight and an exposed position in which the information is visible for simultaneous viewing with the recipes. The information typically includes measurement equivalents or ingredient substitutions. The stand may include a multi-ring binder which is openable for use and closable to a size which fits on a standard bookshelf. The stand may include multiple panels which are foldable between an erect position and a collapsed position. In one embodiment, a binder mechanism on which the pages are mounted is rotatably mounted on the stand between a forward position for displaying the fronts of the pages in an upright position and a reversed position for displaying backs of the pages in an upright position.

### CROSS REFERENCE TO RELATED APPLICATIONS

This application claims priority from U.S. Provisional Application Ser. No. 60/846,297 filed Sep. 21, 2006: the disclosure of which of incorporated herein by reference.

### BACKGROUND OF THE INVENTION

1. Technical Field

The present invention relates generally to display stands or binders, especially collapsible display binders. More particularly, the invention relates to such a display stand or binder for displaying recipes and information cards related to cooking which are movable between a stowed or hidden position and an exposed or visible position. Specifically, the invention relates to such a stand or binder in which the recipe pages may be flipped over via a binding mechanism which may be rotatably mounted in order to facilitate display of the front and rear sides of the pages so that either side of the page may be read while the information pages are simultaneously visible.

2. Background Information

Collapsible display binders have been long known in the art which allow for the presentation of a plurality of pages such that one of the pages may be displayed and then flipped over to allow an underlying page to be subsequently displayed. U.S. Pat. No. 2,146,387 granted to Turnbull and U.S. Pat. No. 2,208,213 granted to Ericson both teach such collapsible binders which were configured in particular to allow a page to be flipped upwardly so that the rear of one page could be displayed along with the front of another page therebelow. Other display binders such as that disclosed in U.S. Pat. No. 2,617,665 granted to Ericson were aimed at flipping the pages from a front display position all the way over to a position substantially behind the binder where the pages are substantially hidden when viewed from the front of the binder.

However, when a chef is using a recipe during the cooking process, he or she may want to view more information than just the recipe itself, such as measurement equivalences and ingredient substitutions. Thus, there is a need for a recipe stand which provides convenient access to such information while the chef is in the process of preparing food. The present invention solves this and other problems in the art.

### BRIEF SUMMARY OF THE INVENTION

The present invention provides an apparatus for displaying recipes, the apparatus comprising: a stand having an upper end and a lower end adapted to sit on a support surface; a page binder mechanism mounted on the stand adjacent the upper end and adapted for mounting pages thereon in a manner which allows the pages hanging down from the binder mechanism to be flipped over in an upward direction; an information card movably mounted on the stand between a stowed position and an exposed position in which the card extends outwardly from the stand; and a front information side on the card with information printed thereon which is visible in the exposed position.

The present invention also provides an apparatus for displaying recipes, the apparatus comprising: a stand; a forward facing page-supporting surface on the stand which angles upwardly and rearwardly; a plurality of pages mounted on the stand and flippable between a home position in which the pages are supported by the page supporting surface and a flipped position in which the pages are not supported by the page supporting surface; an information card movably mounted on the stand between a stowed position and an exposed position in which the card extends outwardly from the stand; and a front information side on the card with information printed thereon which is visible in the exposed position.

### BRIEF DESCRIPTION OF THE SEVERAL VIEWS OF THE DRAWINGS

FIG. 1 is a perspective view of the recipe stand of the present invention with the information cards in the stowed or hidden positions.

FIG. 2 is a front elevational view of the recipe stand with the information cards in the exposed or display positions.

FIG. 3 is a side elevational view of the recipe stand with the binder in an open position displaying the recipe pages.

FIG. 4 is a sectional view taken on line 4-4 of FIG. 3 with portions cut away to show the mounting of the information cards on the binder.

FIG. 5 is a sectional view taken on line 5-5 of FIG. 4 and shows the lower information card in the stowed position.

FIG. 5A is similar to FIG. 5 and shows the lower information card in the display position.

FIG. 6 is a side elevational view of the recipe stand in the collapsed position.

FIG. 7 is a plan view of the spine of the binder and the ring assembly showing the pivotal nature of the ring assembly.

FIG. 8 is a sectional view taken on line 8-8 of FIG. 7 showing a recipe page mounted on the ring assembly with the ring assembly rotated to a reversed position.

### DETAILED DESCRIPTION OF THE INVENTION

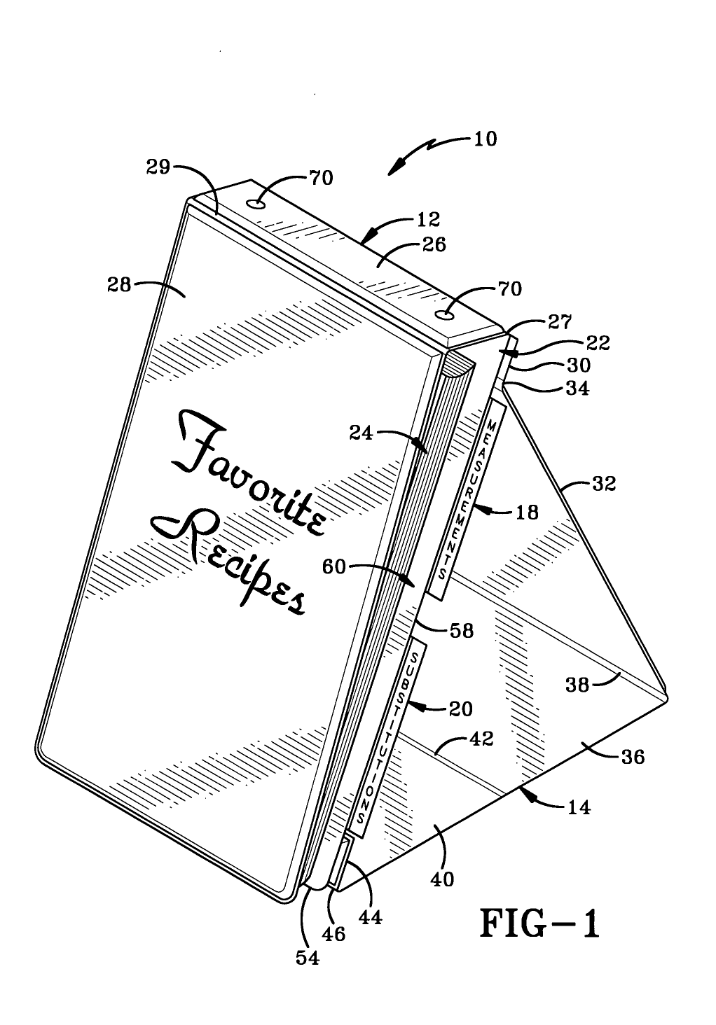

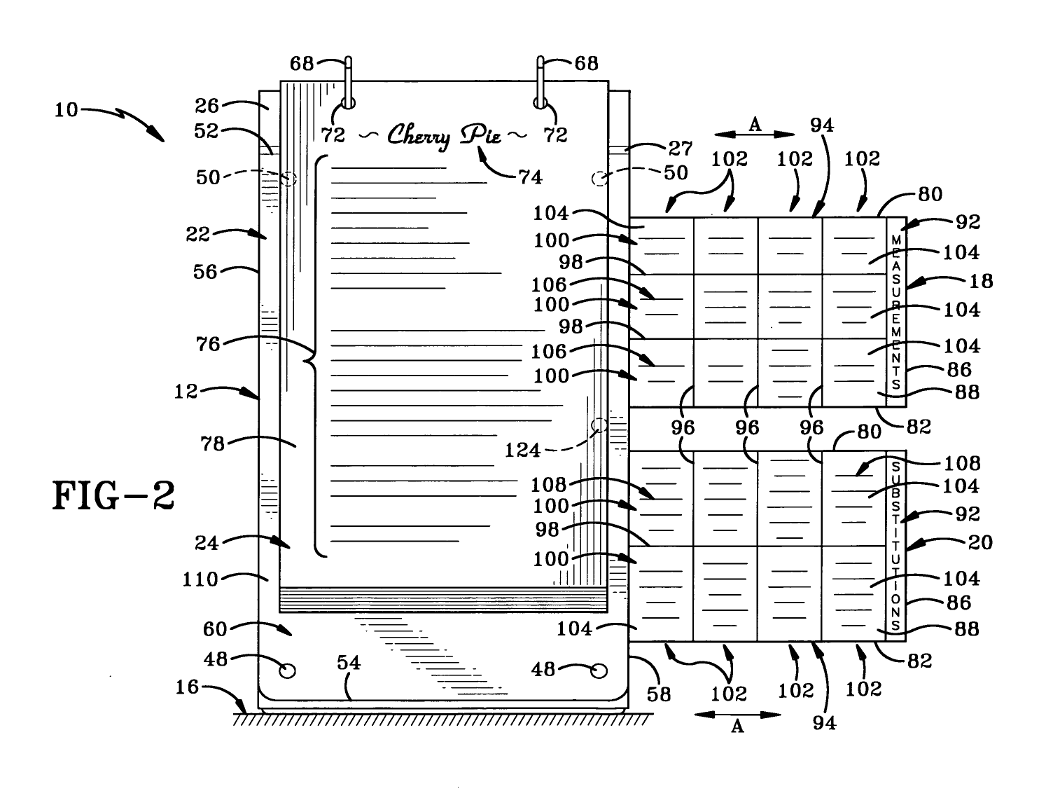

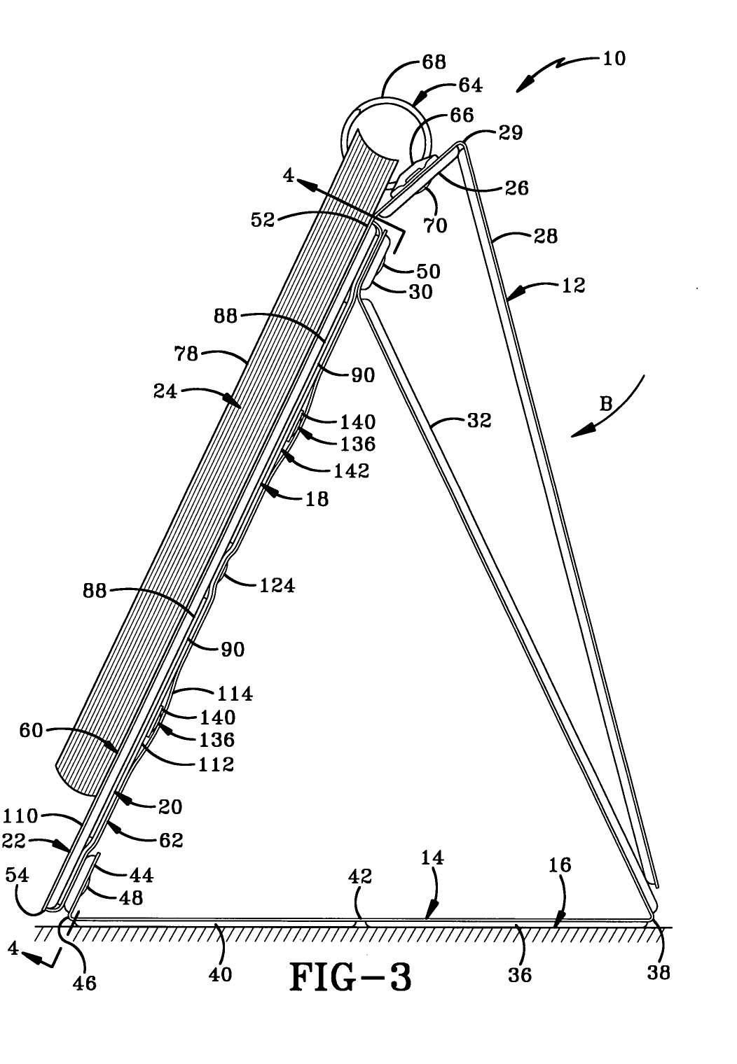

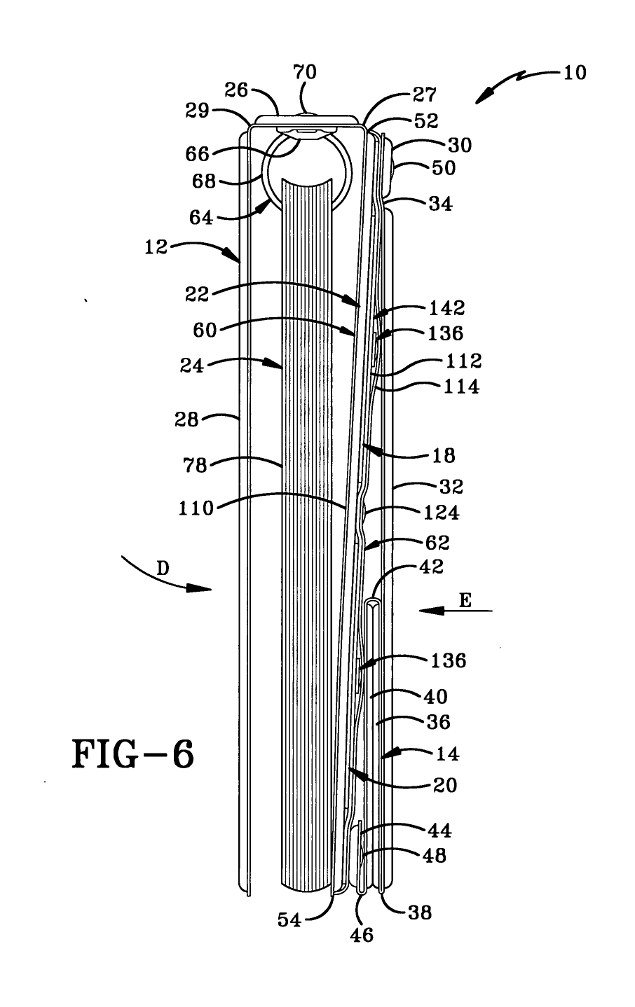

The recipe stand of the present invention is indicated generally at 10 in FIGS. 1-2. Stand 10 includes a two ring binder 12 and a support 14 which is movable between an erect position shown in FIGS. 1 and 3 to allow binder 12 to stand in a generally upright position on a support surface 16 (FIGS. 2-3) such as a kitchen counter and a collapsed position shown in FIG. 6. In accordance with the invention, stand 10 includes upper and lower information cards 18 and 20 which are movable between a hidden or stowed position shown in FIG. 1 and a visible exposed or display position shown in FIG. 2, as indicated at Arrow A in FIG. 2.

Referring to FIG. 1, binder 12 includes a page supporting structure or panel 22 against which a plurality of recipe pages 24 lie when stand 10 is in the erect position and sitting on a support surface 16 (FIGS. 2-3). Stand 10 is a handheld item which in its collapsed position is typically the size of a book or notebook so that it may be stored on a standard bookshelf. While the size of the stand 10 may vary, it is preferably sized for use on a kitchen counter and thus small enough to minimize space used on the countertop while large enough so that recipes on pages 24 and information on cards 18 and 20 is easily legible. Typically, panel 22 (and stand 10 in the collapsed position) has a width in the range of about 5 to 12 inches and more typically about 6 to 7 inches, and a height in the range of about 6 to 12 inches and more typically about 8 to 10 or 11 inches.

Binder 12 also includes a spine 26 which is hingedly connected to panel 22 by a living hinge 27. A cover panel 28 is also hingedly connected to spine 26 by another living hinge 29 so that when cover panel 28 and panel 22 are in a closed position as shown in FIG. 1, they define therebetween a space in which pages 24 are disposed. Support 14 includes an upper mounting flange 30 mounted adjacent an upper end of panel 22 and a rear panel 32 which is hingedly connected to flange 30 via a living hinge 34. Support 14 further includes a rear base panel 36 hingedly connected to rear panel 32 via a living hinge 38, a front base panel 40 hingedly connected to rear base panel 36 via a living hinge 42 and a lower mounting flange 44 which is hingedly connected to panel 40 via a living hinge 46. Hinges 27, 29, 34, 38, 42 and 46 are parallel to one another and in the erected position of stand 10 are horizontal. Said hinges thus represent respective axes about which the various panels pivot or fold and are horizontal in the erected position. Lower flange 44 is connected to panel 22 adjacent a lower end thereof via a pair of fasteners in the form of rivets 48 (FIG. 2). Upper flange 30 is likewise connected to panel 22 via a pair of fasteners in the form of rivets 50 (FIG. 2).

Referring to FIGS. 2-4, panel 22 has a top or top edge 52, a bottom or bottom edge 54, first and second sides or side edges 56 and 58, and front and rear substantially flat surfaces 60 and 62. Thus, when stand 10 is in the erected position shown in FIG. 1 with cover 28 in the closed position, rear panel 32 extends rearwardly and downwardly from adjacent top 52 of panel 22 and panels 40 and 36 are substantially horizontal with panel 40 extending rearwardly from adjacent bottom 54 of panel 22 and panel 36 extending rearwardly from panel 40 to adjacent a lower end of panel 32. In the closed position of binder 12 and erected position of support 14 shown in FIG. 1, spine 26 extends forward in a generally horizontal direction from adjacent top 52 of panel 22 and cover 28 hangs generally downwardly from the front of spine 26 in front of front page-supporting surface 60 of panel 22. When binder 12 is in the open position shown in FIGS. 2-3, spine 26 extends rearwardly from adjacent top 52 of panel 22 and cover panel 28 hangs downwardly from spine 26 in a position rearward of rear surface 62 of panel 22.

Referring to FIG. 3, binder 12 further includes a page binder mechanism in the form of a ring assembly 64 having a generally rectangular base 66 and a pair of spaced rings 68 which are mounted on base 66 and moveable between open and close positions in a standard fashion, the open position not being shown in the figures. Base 66 is fastened to spine 26 by fasteners in the form of a pair of rivets 70 (FIGS. 1-2). Referring to FIGS. 2 and 3, pages 24 define holes 72 for receiving respectively therein rings 68 so that pages 24 hang down from rings 68 when stand 10 is in the erect position. Panel 22 and front surface 60 thereof in the erect position angle upwardly and rearwardly so that pages 24 together are supported on surface 60, more particularly with a back page of pages 24 in contact with surface 60 and the remainder of the pages sequentially resting on one another forward thereof. Pages 24 may simply be pages with recipes printed directly thereon although in the preferred embodiment, pages 24 include protective sleeves having pockets therein in to which paper or the like with recipes printed thereon may be inserted and removed as desired. In any case, each page 24 will typically include a recipe title 74 and a printed textual recipe 76 represented by the horizontal lines printed on a front 78 of page 24. Pages 24 are flippably mounted on rings 68 so that they flip from a home position (FIG. 3) hanging down from rings 68 and supported on surface 60 generally about a horizontal axis passing through the center of rings 68 parallel to the various living hinges to a flipped upside down position extending upwardly from rings 68 and then over the top of the stand to the rear of the stand to rest in a flipped upright position on panel 28 in the open position of FIG. 3.

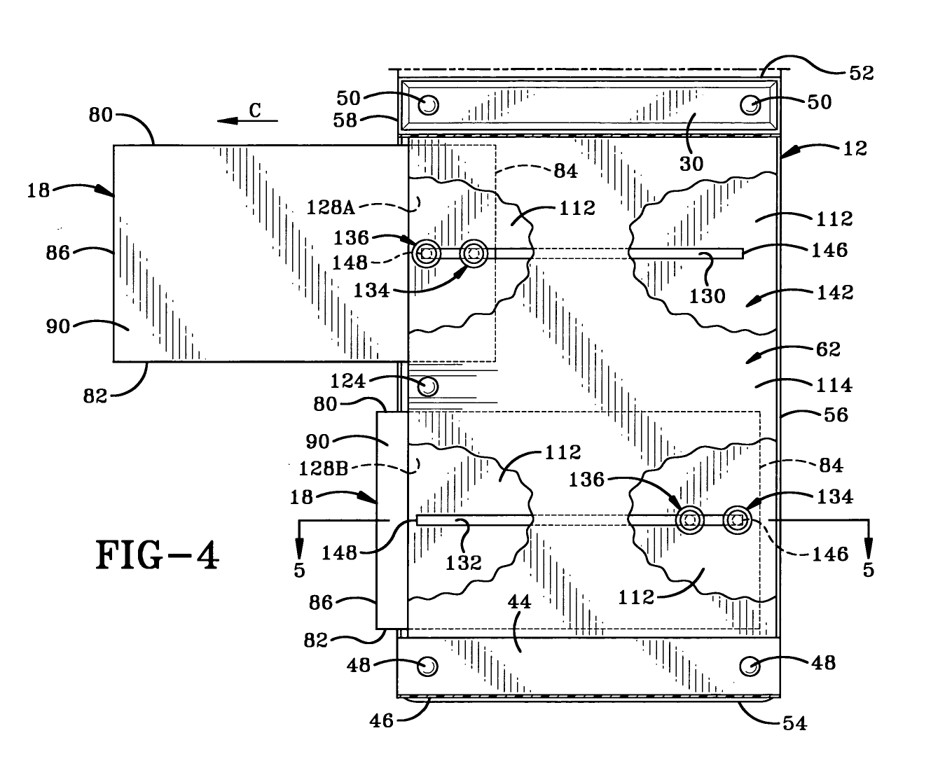

Referring to FIG. 2, each of information cards 18 and 20 have printed thereon information related to cooking which is useful to the chef during the cooking process. Each of information cards 18 and 20 has a top edge 80, a bottom edge 82, first and second side edges 84 (FIG. 4) and 86, a flat front information side 88 and a flat back side 90 (FIG. 4). In the stowed position, each side edge 84 is adjacent and inward of first side edge 56 of panel 22 and each side edge 86 is adjacent and outward of second side edge 58 of panel 22. In the exposed position, side edge 84 is adjacent and inward of side edge 58 and side edge 86 is distal and outward of side edge 58. The textual information related to cooking is printed on the front sides 88 of cards 18 and 20. Each card 18 and 20 includes a category section 92 and a chart section 94. Category section 92 is disposed adjacent second side 86 so that when cards 18 and 20 are in the stowed position (FIG. 1), category section 92 extends outwardly from and adjacent second side 58 of panel 22 so that each section 92 is visible from the front of stand 10. Each section 92 is narrow from side to side and substantially narrower than each section 94. Each section 92 serves as a manual gripping portion which is manually accessible in the stowed position to facilitate moving the cards to the display position. Each category section 92 includes one or more words which specify the category to which the information in the respective chart section 94 is related. Section 92 of card 18 in particular shows the word “Measurements” although other words such as “Conversions” or “Equivalencies” may be used to a similar effect. Section 92 of card 20 includes the word “Substitutions” although other words may work for the purpose. These words are printed vertically to read top to bottom in order to provide a narrow profile of each section 92 which extends outwardly of side 58 of panel 22. Each chart section 94 preferably includes divider lines such as vertical divider lines 96 and horizontal dividing lines 98 which are printed on fronts 88 of the cards. These divider lines form rows 100 and columns 102 each having a plurality of blocks 104 in which specific textual information is printed as represented by the horizontal lines within each block 104. More particularly, each block 104 of card 18 includes textual information indicating a measurement equivalent 106 and each block 104 of card 20 includes textual information indicating an ingredient substitution 108. Some examples of measurement equivalents 106 are “4 cups=1 quart”, “1 stick of butter=½ cup of butter” and “3 teaspoons=1 tablespoon”. Some examples of ingredient substitutions 108 are “1 cup sweet milk=1 cup sour milk+1 teaspoon soda” and “1½ cups corn syrup=1 cup sugar+Y cup water”.

While the size of cards 18 and 20 may vary, they most typically have a height from top edge 80 to bottom edge 82 in the range of 2 to 5 inches and a width from first side edge 84 to second side edge 86 in the range of 4 to 8 inches. The height of the cards is more typically about 3 to 4 inches and the width more typically about 5 to 6 inches. Category section 92 typically has a width of about 3/16 to 1 inch, more typically ¼ to ¾ inch and even more typically about ¼ to ½ inch. Section 92 thus also represents the width of the portion of each card 18 and 20 which extends outwardly from second side 58 of panel 22 in the stowed position. Chart section 94 is substantially wider than category section 92. Typically, section 94 is in the range of 5 to 15 times wider than section 92, more typically from 8 to 15 times wider and usually 10 to 15 times wider.

Referring to FIGS. 3-5, page supporting panel 22 and the mounting of information cards 18 and 20 is described in further detail. Panel 22 includes several layers or walls. More particularly, panel 22 includes a main structural wall 110, a mounting wall 112 and a cover wall 114. Main wall 110 includes a primary structural internal wall 116 which is typically formed of a relatively rigid material such as metal, wood, cardboard, plastic or the like. Internal wall 116 is encased by a covering including front and rear layers 118 and 120 typically formed of a plastic material which provides an aesthetically pleasing appearance and waterproof characteristics. Spine 26, panels 28, 32, 36 and 40, and flanges 30 and 44 all have a structural configuration analogous to that of main wall 110. Mounting wall 112 is secured to the main wall 110 by rivets 48, 50 and an additional rivet 124 (FIGS. 2-4). Cover wall 114 is connected in a continuous fashion along top 52, first side 56, and bottom 54 of panel 22 so that wall 114 and wall 110 define therebetween a flat pocket or interior chamber 126 having an entrance opening 128 which opens along second side 58 of panel 22. More particularly, rivet 124 passes through a portion of cover wall 114 adjacent second side 58 centrally between top 52 and bottom 54 in order to form upper and lower entrance openings 128A and 128B through which cards 18 and 20 are respectively laterally slidable into and out of interior chamber 126. Cards 18 and 20 typically slide side to side in a horizontal direction. Cover wall 114 is typically made of a flexible material and is an optional structure which provides for aesthetic appeal although it is not necessary to the function of stand 10.

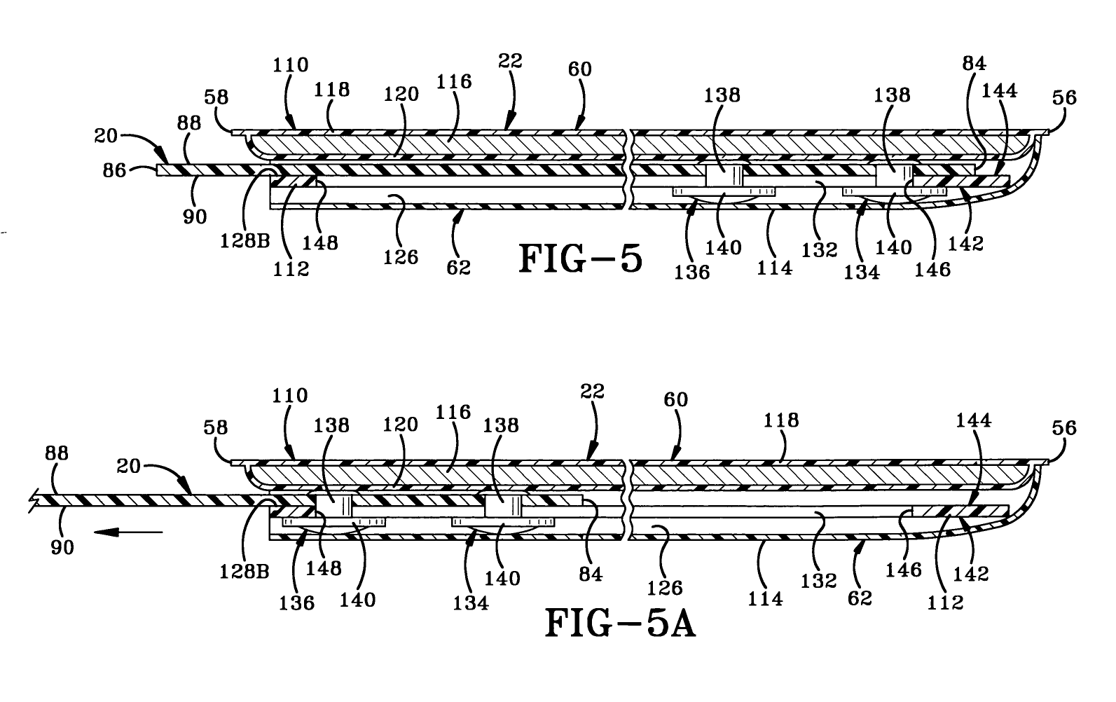

Mounting wall 112 defines upper and lower elongated openings or slots 130 and 132 which are substantially straight and horizontal. Each of said slots extends from adjacent first side 56 to adjacent second side 58 of panel 22. Connected to each card 18 and 20 are a pair of fasteners in the form of rivets 134 and 136, each having a short shaft 138 disposed in a respective one of slots 130 and 132 and an enlarged head 140 which is larger than the width of the respective slot and which slidably engages a rear surface 142 of mounting wall 112 during the movement of the cards into and out of interior chamber 126. Likewise, back 90 of each card 18 and 20 slidably engages a front surface 144 of mounting wall 112 and fronts 88 slidably engage the rear surface of main wall 110 during the sliding movement of cards 18 and 20 between the stowed and displayed positions. Each of slots 130 and 132 has first and second ends 146 and 148. In the stowed position, shaft 138 of rivet 143 abuts first end 146 of the respective slot as shown in FIG. 5. In the display position of the information cards, shaft 138 of rivet 136 abuts second end 148 of the respective slot, as shown in FIG. 5A.

The operation of stand 10 is described briefly although it should be fairly evident in light of the description thus far. As shown in FIG. 1, stand 10 is opened to the erect position. Cover panel 28 is then flipped upwardly and over top 52 of panel 22 and then downwardly behind panel 22 and panel 32 as indicated at arrow B in FIG. 3 to open binder 12 to expose recipe pages 24 so that recipe 76 may be conveniently read during the cooking process. Information cards 18 and 20 are slid outwardly as indicated at arrow C in FIG. 4 so that cards 18 and 20 are moved to the display position. As previously noted, the textual information of the recipe and the information on cards 18 and 20 thus face forward in a manner which is conveniently accessible to the chef so that chef does not have to search for such information during the cooking process. In addition, information cards 18 and 20 are preferably made of material that is easily cleaned such as a plastic material so that ingredients which stick thereto during the process of cooking will be easily removable. When the chef is finished using stand 10, information cards 18 and 20 are simply slid back into the stowed position within interior chamber 126 and cover panel 128 is flipped back to its closed position as indicated at arrow D in FIG. 6. Panels 32, 36 and 40 are then folded from the generally triangular erected configuration to the collapsed position as shown at arrow E in FIG. 6 via the hinges 34, 38, 42 and 46. In the collapsed position shown in FIG. 6, the various panels and pages 24 are generally parallel so that stand 10 forms a generally flat rectangular parallelepiped configuration so that stand 10 may then be put away on a bookshelf along with other cookbooks or the like.

It will be appreciated by one skilled in the art that various changes may be made to stand 10 which are within the scope of the present invention. For instance, the particular structure which provides for the horizontal sliding of information cards 18 and 20 may take various configurations. In addition, another effective manner of moving the information cards from the stowed position to the display position is to pivotally connect them to a mounting wall. This might involve a single pivot on which both cards are pivotally mounted or separate pivots which the cards are individually pivotally mounted. Preferably, such an arrangement would include a stop mechanism which would stop the card from pivoting outwardly too far and maintain the card in the display position. In addition, the exemplary embodiment shows that each information card utilizes a pair of fasteners or rivets disposed in the respective slot so that when the card is pulled out to the display position it does not rotate downwardly under its own weight. A single elongated rivet or fastener might be used instead of two separate rivets. In addition, other stops may be utilized to prevent such a rotational movement in order to maintain the cards in the proper display position. The slots formed in the mounting wall may also be formed in the main wall of panel 22 although with certain materials this may not be desirable due to the weakening of the structure thereof. In addition, other binding mechanisms may be used besides a ring assembly to allow the recipes to be mounted on the binder while allowing them to be flipped over. While the openable rings of the ring assembly are generally preferred to allow for the insertion and removal of recipe pages, this is not required. Other variations will be evident to one skilled in the art.

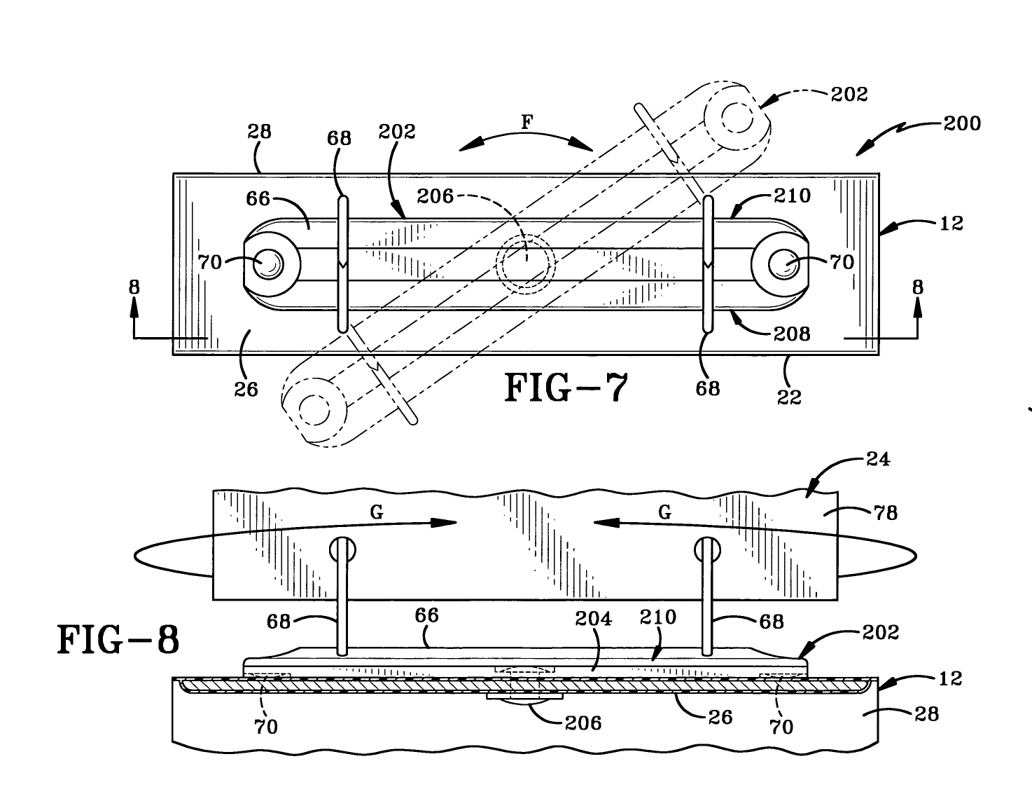

Referring to FIGS. 7 and 8, recipe stand 200 is described. Recipe stand 200 is the same as stand 10 except for the pivotal mounting of the binder mechanism. More particularly, stand 200 includes a page binder mechanism in the form of a ring assembly which may include base 66 and rings 68 as used in stand 10. Assembly 202 further includes a substantially rectangular mounting plate 204 to which base 66 is mounted via rivets 70. Mounting plate 204 is pivotally mounted on spine 26 via a pivot 206 extending therebetween, as indicated at arrow F with the partially rotated position shown in dot-dash lines in FIG. 7. The binder mechanism rotates about an axis which passes through pivot 206 and is perpendicular to spine 26 and to the various living hinges or axes about which the various panels pivot of fold. The solid lines of FIG. 7 show assembly 202 positioned so that a front 208 thereof faces forward toward panel 22 and a rear 210 faces rearwardly toward panel 28. As shown in FIG. 8 at arrows G, assembly 202 may be rotated 180 degrees about pivot 206 so that rear 210 faces forward. This allows for the reversing of the orientation of pages 24. As indicated in FIG. 8, a page 24 is shown upside down with a front 78 thereof having rotated from a position corresponding to FIG. 7 so that in FIG. 8 the front 78 of page 24 faces forward in the upside down position. Thus, when pages 24 are flipped forward and downwardly via rings 68 to hang down therefrom in front of the stand and lay against page supporting panel 22, recipes which are printed on the rear of pages 24 will now be visible in an upright position when stand 200 is in the erect position with binder 12 open as shown in FIG. 2 with reference to stand 10. Thus, stand 200 allows recipes printed on the rear of the pages to be easily positioned so that the information on cards 18 and 20 is simultaneously visible therewith.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus for displaying recipes, the apparatus comprising:
a stand having an upper end and a lower end adapted to sit on a support surface;
a page binder mechanism mounted on the stand adjacent the upper end and adapted for mounting pages thereon in a manner which allows the pages hanging down from the binder mechanism to be flipped over in an upward direction;
an information card movably mounted on the stand between a stowed position and an exposed position in which the card extends outwardly from the stand; and
a front information side on the card with information printed thereon which is visible in the exposed position.

2. The apparatus of claim 1 wherein the information printed is related to cooking and comprises one of a measurement equivalent and an ingredient substitution.

3. The apparatus of claim 1 wherein at least part of the information is hidden from sight in the stowed position.

4. The apparatus of claim 3 further comprising a forward facing page-supporting surface on the stand adapted to support the pages thereon when the pages are positioned in front of the page-supporting surface; and wherein the hidden information is disposed behind the page-supporting surface in the stowed position.

5. The apparatus of claim 1 wherein the stand has first and second opposed sides; and the information card has first and second opposed side edges; in the stowed position the first and second edges of the card are respectively adjacent the first and second sides of the stand; and in the exposed position the first side edge of the card is adjacent the second side of the stand.

6. The apparatus of claim 1 further comprising first and second sections on the information card; and wherein in the exposed position the first and second sections extend outwardly from the stand; and in the stowed position only the first section extends outwardly from the stand.

7. The apparatus of claim 6 wherein the first section is a category section; and further comprising printed information on the second section; and printed information on the category section specifying the category to which the information on the second section is related.

8. The apparatus of claim 1 further comprising divider lines on the information side bounding rows and columns of blocks; and wherein information is printed in the blocks.

9. The apparatus of claim 1 further comprising a manual gripping portion on the information card which is manually accessible in the stowed position.

10. The apparatus of claim 1 wherein the information card is slidably mounted on the stand to slide between the stowed and exposed positions.

11. The apparatus of claim 10 further comprising a slot formed in the stand; and a shaft connected to and extending outwardly from the information card and disposed in the slot so that the shaft is slidable within the slot during movement of the information card between the stowed and exposed positions.

12. The apparatus of claim 1 further comprising a flat pocket which is formed in the stand and has an entrance opening; and wherein the information card is movable through the entrance opening into and out of the pocket between the stowed and exposed positions.

13. The apparatus of claim 1 further comprising a shaft connected to and extending outwardly from the information card for mounting the card on the stand.

14. The apparatus of claim 1 further comprising a plurality of pages flippably mounted on the binder mechanism to flip upwardly and over from a home position in which the pages hang down from the binder mechanism in front of the stand to a second flipped position; and wherein in the stowed position at least part of the information printed on the card is behind the pages in the home position.

15. The apparatus of claim 1 further comprising a spine on the stand; a first hinge; a first panel hingedly connected to the spine via the first hinge; a second hinge spaced from the first hinge; and a second panel hingedly connected to the spine via the second hinge; and wherein the binder mechanism is mounted on the spine between the first and second hinges.

16. The apparatus of claim 1 further comprising a first panel on the stand; a forward facing page-supporting surface on the first panel adapted to support the pages when in front of the page-supporting surface; and a support mounted on and extending rearwardly from the first panel and adapted to contact the support surface.

17. The apparatus of claim 1 wherein the stand is foldable between an erect position and a collapsed position.

18. The apparatus of claim 1 further comprising a pivot extending from the stand to the binder; and wherein the binder mechanism has front and back sides and is mounted on the pivot to rotate relative to the stand between a forward-facing position in which its front side faces forward and a rearward-facing position in which its rear side faces forward.

19. The apparatus of claim 1 further comprising a plurality of pages each flippably mounted on the binder mechanism and having a front and a back; and wherein the binder mechanism has front and back sides and is movable relative to the stand between a forward-facing position in which its front side faces forward and a rearward-facing position in which its rear side faces forward so that in the forward-facing position the fronts of the pages face forward when hanging down from the binder mechanism in front of the stand and in the rearward-facing position the backs of the pages face forward when hanging down from the binder mechanism in front of the stand.

20. An apparatus for displaying recipes, the apparatus comprising:
a stand;
a forward facing page-supporting surface on the stand which angles upwardly and rearwardly;
a plurality of pages mounted on the stand and flippable between a home position in which the pages are supported by the page supporting surface and a flipped position in which the pages are not supported by the page supporting surface;
an information card movably mounted on the stand between a stowed position and an exposed position in which the card extends outwardly from the stand; and
a front information side on the card with information printed thereon which is visible in the exposed position.
